(19) United States
(12) Patent Application Publication
(10) Pub. No.: US 2008/0288540 A1
(43) Pub. Date: Nov. 20, 2008

(54) Method of Access to Personal Information

(76) Inventors: Carl Jarvis, Mount Laurel, NJ (US); James Gentilin, Lumberton, NJ (US)

Correspondence Address: LICATA & TYRRELL P.C., 66 E. MAIN STREET, MARLTON, NJ, 08053, US

(21) Appl. No.: 12/095,945

(22) PCT Filed: Dec. 15, 2006
(86) PCT No.: PCT/US06/62146

§ 371 Date: Jul. 2, 2008

Related U.S. Application Data
(60) Provisional application No. 60/750,567, filed on Dec. 15, 2005.

(51) Int. Cl. G06F 17/30; G06K 19/00

(52) U.S. Cl. 707/104.1; 235/487; 707/E17.044

(57) ABSTRACT

Methods and systems to store and access personal and medical information, inclusive of, but not limited to access in an emergency situation, routine medical care, or a means to archive personal and medical information, and events, by an individual, a caregiver or guardian, and/or a medical professional are provided.

This patent application claims the benefit of priority from U.S. Provisional Application Ser. No. 60/750,567, filed Dec. 15, 2005, teachings of which are herein incorporated by reference in their entirety.

### FIELD OF THE INVENTION

The present invention relates to methods and systems to store and access personal and medical information of an individual, inclusive of, but not limited to, access in an emergency situation, routine medical care, and a means to archive personal and medical information and events by the individual or a caregiver or medical professional.

### BACKGROUND OF THE INVENTION

Personal information including personal medical information can be stored and accessed in a variety of ways including paper copies and records, electronic records stored and created by an individual, or electronic records stored and created by pharmacists, pharmacy benefit managers, physicians, hospitals, long term care facilities, and many others. Current technologies used to access information are provided by phone, FAX, internet access, and call centers. However, access to information in an emergency situation can be limited in content, availability, and response time.

Allowing access to personal and medical information controlled by the individual or caregiver can ensure that medical treatment in an emergency will benefit by access to the information, avoiding the medical response team from treating blindly. Information may include, but is not limited to, the individuals name, age, any medical conditions, allergies, medications, blood type, and emergency contacts.

### SUMMARY OF THE INVENTION

The present invention provides methods and systems for an individual, caregiver, medical professional or other organization or service to have access to an individual's personal or medical information, as well as the ability to share information with the consent of the individual, or caregiver, in a medium which provides access to the information in the quickest response time. The present invention utilizes telephony hardware, telephony services and/or the internet to access and/or share this information.

An aspect of the present invention relates to methods and systems for defining medical and personal information of an individual in a database to be shared with a first emergency responder or other organization or service.

Another aspect of the present invention relates to methods and systems for a first emergency responder or other organization or service to access and obtain medical and personal information of an individual in a database.

Yet another aspect of the present invention relates to devices providing a unique identification number associated with an individual and which provides access to their medical and personal information.

### DETAILED DESCRIPTION OF THE INVENTION

The present invention provides methods and systems of entering, storing, and accessing personal and medical information utilizing telephony hardware, telephony services and/or the internet. The method of entering, or storing data is not restricted as part of this present invention and can be entered by any means capable of entering such data, inclusive of, but not limited to, internet services and applications, personal computer (PC) applications, databases, or call centers. The present invention does not define, or constrain the data content itself. However, the present invention does restrict the entering, storing, and access of personal and medical information which is entered, selected, and/or stored by the individual or a caregiver or guardian thereof, for access through telephony hardware, telephony services, and/or the internet. The present invention also restricts the entering, storing, and access of personal and medical information which the individual, caregiver, or guardian consents to access, and selects which information they want to share, and how they want to share it, whether it is through internet access only, phone access, or deciding which content is searchable by a first emergency responder and/or other organizations or services. Such information may include, but is not limited to, health insurance information, member numbers, medicare number, phone number, cell phone number, social security number (SS/N), and driver's license number. A preferred embodiment of the systems of the present invention utilizes a device such as, but not limited to, a wrist band, cell phone, cell phone number, home phone number, wallet card, pendant, smartcard, key fob or sticker to establish identification of the individual associated with the personal and medical information which is stored and can be accessed in accordance with the present invention.

Medical and personal information can be entered into a database of the system of the present invention by the individual or a caregiver or guardian thereof. Medical and personal information pertaining to the individual can also be entered or imported into the database of the system of the present invention by other organizations or services via, for example, the databases of these other organizations or services.

Information and access may be both of secure and non-secure content. All of the data stored on the server is secure and may be encrypted using the latest security technologies. Secure content can be restricted in access. The individual, caregiver or guardian who enters the data determines which, if any, information can be non-secure. Non-secure content allows access to that information through the internet, or any phone, without involving a third party. All data which is tagged as non-secure is considered to be public data.

In a preferred embodiment of the present invention, automated data access is through telephony access. Access to non-secure, or public data, is provided by calling an emergency information system and entering an emergency access number. The emergency access number may comprise letter(s), number(s), or may be an alpha-numeric combination. If the individual has entered data and selected the data to be non-secure, the caller will hear an automated voice response based on the data content. The voice response may be generated through voice recordings, Text-To-Speech (TTS) technology, or a combination of both. The process used in converting text to speech is not limited to the language output. Current technologies allow for language conversions in languages other than English, such as, Spanish, English (UK), French, German, Mandarin, and many others. To facilitate the fastest response time, the individual can allow emergency access to their information by using other unique individual numbers, which can be accessed by other systems facilitated by the medical community. As an example, the individual can enter their cell phone number into the database for use for auto access. A first emergency responder such as an emergency medical technician (EMT) or other person aiding the individual can then use that individual's cell phone to call the emergency information system and the data will automatically be outputted without the need of entering the emergency access number. In this embodiment, information is accessed by, for example, a caller ID technology such as CID technology. In addition, the individual may enable caller ID access which will only allow access for callers which can be identified through CID technologies. This methodology can restrict access to public data, as well as provide a means of creating a private telephony network Data for an individual which may be accessed through telephony technologies may be different from data for the individual accessed through other means such as web access. This facilitates and limits the information in an emergency situation to only the data content that is relevant.

In some embodiments, upon entry of the emergency access number, the system will automatically dial an emergency contact for that individual. This may be done, for example, by call forwarding technology or 3-way calling.

The output methods used in the present invention may also refer to information stored or associated with an individual, such as personal information, or personal health information. This can include personal identifiable content such as a person's name, address, and contact information, emergency contact information, or personal health information, inclusive of, but not limited to, age, weight, gender, blood type, allergies, medical conditions, medical history, or current medications used including prescription, over-the-counter (OTC), and herbal remedies.

For the purpose of the present invention, by “emergency information”, it is meant, any information in the database which is tagged as shareable and includes both secure and non-secure data.

By “non-secure data”, it is meant any information which the individual has selected as information they deem to be public data, or any data which they do not want to restrict access to. This information may include personal information, identifiable information, medical information, emergency contact information, and directives. Examples of non-secure data include, but are not limited to, a person's name, either first, last, nickname, or a combination thereof. This information may also include any medical conditions, for example, but in no way limited to, pregnancy, diabetes, Alzheimer's disease, Parkinson's disease, and cancer. This information may also include any allergies, and the severity of the allergy, for example, but in no way limited to, a life threatening allergy to nuts. Non-secure information may also be emergency contact information, such as a spouse's name and cell phone number, or parents, friends, or guardian information. In addition, this information may include, but is not limited to, advance directives, living wills, organ donation, and/or a DNR-Do Not Resuscitate order. For the sake of privacy, some secure information may be restricted from allowing that information to be tagged as non-secure based on content. For example, the application may restrict the individual's date of birth and/or social security number from being tagged as non-secure or public data. This data would remain as secure data.

By “secure data”, it is meant any information entered and stored, access to which is only obtained by the methods defined within the application. This data may also be encrypted using industry standard encryption methodologies. Access to secure data may be obtained, for example, by an access number, username, password, and/or pin. Access to secure data may also be limited to Virtual Private Networks (VPNs), URLs, email accounts, or any other means of identifying and limiting transmission to the receiving party. Upon entry, all of the data is deemed as secure, and only the individual, caregiver or guardian who can enter, or edit, the information can decide who else can access the information.

By “access”, it is meant, any means by which data is shared. This access means may include internet protocols, including web access, email access, VOIP, and any other data protocol, wired or wireless, which uses the internet as its backbone architecture. This access means may also include any telephony based access or telephony technologies including wired and wireless transmissions, such as, but not limited to, phone, FAX, cell phone, pager, or any other messaging service, or protocol. Access may also be provided by automating the process through use of caller ID (CID).

By “application”, it is meant the means by which data is entered and the means by which data is stored.

Various means or devices for notification that an individual is a member of the medical and personal information system of the present invention can be used. Examples include, but are in no way limited to, wristbands, keyfobs, pendants, wallet cards, smartcards, driver's license stickers, and stickers for mobile device(s) such as cell phones, PDAs, BLACKBERRYs, pagers, etc., which include a unique identification number or Emergency Access Number or an identification label, and may or may not include a username, password or pin. The Emergency Access Number may be reproduced on such means via a permanent label, a printed label, pad printing, debossing, embossing, engraving, a magnetic strip or barcode or any other means capable of placing or programming the emergency access number on the notification means or device. Additional preferred information included on the means or device includes, but is not limited to, an emergency information number or website reference.

In a preferred embodiment, the notification device comprises a wristband of silicon, or a composite material or components. Manufacturing processes for this exemplary notification device include, but are not limited to, overmolding (twin shot), liquid injection molding, and compression molding. The unique identification number can be applied to the wristband by various techniques including, but in no way limited to, engraving, printing, silk-screening, embossing, and/or debossing. Most preferred is a wristband comprising two or more distinct parts or layers, each part or layer being a distinct color so that upon engraving a unique identification number through the first part or layer the differing color of the second part or layer is exposed. In this embodiment, the unique identification number is highly visible and less susceptible to wearing off. Various additives, pigments and/or dyes can be added to the silicone to arrive at parts or layers of differing color. Preferred for some embodiments are phosphorescent or fluorescent additives, pigments or dye.

The following nonlimiting examples are provided to further illustrate the present invention.

### EXAMPLES

### Example 1

### Method of Establishing Identification Using a Wristband

In this example, the individual wears a wristband comprised of silicone and constructed of two layers of contrasting colors so as to highlight a unique ID number through the process of engraving the outer color to expose the inner color. To accentuate the wristband, the wristband may further comprise a fluorescent or phosphorescent material added to the silicone.

### Example 2

### Method of Establishing Identification Using a Cell Phone

In this example, a person's cell phone number is used to establish identification. This can occur by a first responder establishing the number of the cell phone through the cell phone or by calling another number which utilizes caller ID.

### Example 3

### Method of Establishing Identification Using a Wallet Card

In this example, a wallet card has a unique ID number printed on the card.

### Example 4

### Method of Identifying Membership or Services

In this example, identification of membership or services which allow access to information may be displayed by providing a phone number or website reference. This information may be applied to a notification device such as a wristband or wallet card or printed on a sticker applied to a notification means such as a driver's license or a mobile device such as a cell phone, PDA, BLACKBERRY, pager, etc. The wristband preferably has the phone number and website debossed in the band, the wallet card would have the phone number and website printed on the card, and a driver's license or mobile device would have a sticker on it with the phone number and website.

### Example 5

### Method of Access Through Website Services

In this example, a website is used to provide access to shared information. First responders need to enter a unique ID number, or a searchable number defined within the individual's account. Once a unique ID number is entered, a report is displayed and available for printing and/or importing. If allowed, a first responder enters a person's driver's license number, serial number, or other number which they obtain from other sources.

### Example 6

### Method of Data Exchange Through Use of the Wallet Card

In this example, a wallet card contains a barcode or magnetic strip which is scanned by another medical information system which uses the unique ID number contained in the barcode or magnetic strip to search the database of the present invention and import data which the individual selects as shareable. If a first responder has an account to access the system of the present invention and logs into these services, the information shared may include additional information not otherwise obtainable in the non-secure “public data” scenario. For example, the additional information may include, but is not limited to, living wills, advance directives, physician information, etc.

### Example 7

### Method of Access Through an Individual's Cell Phone

In this example, emergency access to the individual's information is obtained using the individual's cell phone and calling the emergency information system of the present invention. The system of the present invention recognizes the individual's cell phone number and then plays the individual's shareable information. The system then prompts the first responder to automatically call the first emergency contact in the person's list.

What is claimed is:

1. A system for defining medical and personal information of an individual in a database to be shared with a first emergency responder or other organization or service comprising:
(a) providing a means for entry of medical and personal information of an individual, into a database;
(b) providing a means for the individual or a caregiver or guardian thereof to select which of the entered medical and personal information they want to share; and
(c) allowing access to information entered in the database which is identified as shareable so that the first emergency responder or other organization or service can access the shared information of the individual.

2. The system of claim 1 wherein medical and personal information is entered into the database by the individual or caregiver or guardian thereof.

3. The system of claim 1 wherein medical and personal information pertaining to the individual is entered or imported into the database by other organizations or services.

4. The system of claim 1 wherein the first emergency responder or other organization or service accesses the shared information by entry of an individual unique identification number.

5. The system of claim 4 further comprising a wristband, pendant, keyfob, or mobile device worn, or carried by the individual with the unique identification number of the individual.

6. The system of claim 4 further comprising a sticker placed on the individual's driver's license or mobile device with the unique identification number of the individual and/or a reference to access the system.

7. The system of claim 4 further comprising a wallet card or smartcard on which the unique identification number of the individual is printed or programmed into the card.

8. The system of claim 4 wherein the unique identification number comprises the individual's cell phone number and entry of said number by the first emergency responder or other organization or service provides access to the individual's information.

9. A system for a first emergency responder or other organization or service to access and obtain medical and personal information of an individual in a database comprising:
(a) a means for accepting entry via telephone or internet a unique identification number of an individual;
(b) a database or report containing medical and personal information of the individual accessible upon entry of the individual's unique identification number; and
(c) an output containing medical and personal information of the individual identified as shareable.

10. The system of claim 9 wherein the output is via a voice, Text-To-Speech (TTS), or audio reproduction capabilities output means.

11. The system of claim 9 further comprising a wristband, pendant, keyfob, or mobile device worn, or carried by the individual with the unique identification number of the individual.

12. The system of claim 9 further comprising a sticker placed on the individual's driver's license or mobile device with the unique identification number of the individual and/or a reference to access the system.

13. The system of claim 9 further comprising a wallet card or smartcard on which the unique identification number of the individual is printed or programmed into the card.

14. The system of claim 9 wherein the unique identification number comprises the individual's cell phone number and entry of said number by the first emergency responder or other organization or service provides access to the individual's information.

15. The system of claim 9 wherein access to the individuals information is achieved by dialing via the individual's cell phone.

16. A notification device for a unique identification number comprising:
(a) two or more distinct parts or layers of two or more distinct colors; and
(b) a unique identification number providing access to a medical and personal information system, said unique identification number engraved through the first part or layer of one distinct color to expose the second part or layer of a different color.

17. The notification device of claim 16 wherein the parts or layers comprise silicone formed into a wristband.

18. The notification device of claim 17 wherein a phosphorescent or fluorescent additive, pigment or dye is added to the parts or layers of silicone for distinct colors.
